(19) United States
(12) Patent Application Publication
(10) Pub. No.: US 2016/0199988 A1
(43) Pub. Date: Jul. 14, 2016

(54) Clipper Positioning Device

(71) Applicant: Gerald C. Altomare, Franklin Lakes, NJ (US)

(72) Inventor: Gerald C. Altomare, Franklin Lakes, NJ (US)

(21) Appl. No.: 14/991,632

(22) Filed: Jan. 8, 2016

Related U.S. Application Data
(60) Provisional application No. 62/101,305, filed on Jan. 8, 2015.

(51) Int. Cl. B26B 19/20; B26B 19/38

(52) U.S. Cl. CPC B26B 19/20; B26B 19/3873

(57) ABSTRACT

The present invention provides a device for offsetting an electric hair cutter unit from a subject receiving a haircut. The offsetting device may be adjusted to cut, trim, or style during a haircut. The positioning device may be fixedly attached and/or easily attached and removed from the hair clipper unit. In general, the present invention facilitates an operator cutting hair at a pre-determined length and angle.

### CROSS REFERENCE TO RELATED APPLICATIONS

This application claims priority to the U.S. Provisional Application No. 62/101,305; filed Jan. 8, 2015, entitled CLIPPER POSITIONING DEVICE, the contents of which are relied upon and hereby incorporated by reference.

### FIELD OF THE INVENTION

The present invention generally relates to a hair clipper positioning device for use with powered hair clippers. More particularly it relates to a device for powered hair clippers to permit one or more shearing positions using a single cutting instrument.

### BACKGROUND

While the use of powered hair clippers is well known, such devices have been adapted primarily for shaving and close cropping including the use of attachments interposed between the clipping blade and the subject to lessen the amount of hair removed. To a lesser extent powered clippers are used to cut, trim or style hair of substantial length (i.e., on the order of several inches) determined between an operators fingers. Clippers used in this way require significantly more operator skill to achieve a satisfactory result.

Generally, known hair cutting devices include a cutting unit with blades that move relative to one another to create a cutting motion under the power of an electric motor. The cutting device is normally mounted on a casing housing a motor driving the blades for the hair cutting device. To define a certain cut length, a comb unit may be mounted on the casing covering the cutting unit. The actual cutting length is defined by the length of the comb unit's teeth. The hair length is equivalent to the distance of the blades to the subject. To enlarge the range of usability of the clipping device, attachable comb units with fins of various lengths and/or adjustable with respect to the cutting unit are provided to allow for haircuts of different lengths and in some cases different angles. With longer hair styles, a clipper comb with fins is not an efficient a mechanism of lifting hair to the cutting blades so fixed combs and adjustable combs are less useful for longer cuts.

In another way to cut hair, including longer hair styles, a vacuum unit mounted behind the clipper draws hair up to the blades. The hair length remaining is equivalent to the distance of the blades to the skin which is determined by one or more hollow spacers which convey the vacuum to the scalp and pull the hair to the blades. This approach can be noisy and cumbersome and requires the use of relatively expensive equipment. Especially for non-professional users, there remains the need for an improved a mechanism to determine the length and/or angle of hair remaining after it is cut.

U.S. Pat. No. 175,141 discloses hair clipper comb plate attachments which permit variable spacing of the clipper from the subject's head. U.S. Pat. No. 257,690 discloses a hair grooming attachment affixed onto the hair clipper. U.S. Pat. No. 5,084,973 discusses the use of an adjustable spacing element. These designs do not provide positioning assistance to operators styling hair of substantial length particularly where the operator uses their fingers to guide hair through the clipping element.

U.S. Pat. No. 2,941,293 discloses a motor-driven, self-operated hair clipper with an adjustable length-of cut guide. This hair clipper operates without a pneumatic aid to lift the hair from the scalp and is limited to cutting hair to relatively short lengths as compared to many modern hair styles. U.S. Pat. No. 3,138,870 describes a vacuum operated hair clipper wherein the air movement created by the vacuum operates a turbine connected to the cutting mechanism in addition to removing the cut hair. U.S. Pat. No. 3,272,209 teaches the combination of a hair cutter and a head mounted guide. The head mounted cutter guide is a cumbersome cage like device, unnecessary to the herein claimed invention. Also, the patentees make no provision for lifting the hair from the scalp to assure regulated cutting length.

U.S. Pat. No. 3,648,370 discloses a tapering shoe comb adapted for use in detachable connection with a hair clipper. The detachable comb permits a plurality of positions of adjustment to accommodate a wide range of selected lengths of hair. In particular, a hand adjustment wheel on the outside of the shoe comb is graduated so that a hair stylist can adjust the position of the comb to a predetermined position. The detachable comb is limited, however, to uniform adjustment across its width and still requires a stylist's skill to achieve a proper tapering effect.

U.S. Pat. No. 3,900,949 discloses a powered hair cutter with a hollow open-ended enclosure including a hair movement mechanism for drawing a subject's hair therein where a cutter severs the hair and the hair movement mechanism simultaneously removes the hair cuttings. There is attached to the hollow enclosure movable a spacer mechanism for selectively locating the cutting apparatus relative to the subject's head for predetermining the length of cut hair. This spacer mechanism includes a wheel, however, which invariably will become entangled in the subject's hair. Of course, this hair cutting apparatus is intended to replace standard hair clippers and not merely to adapt them to accurately cut longer hair, as does the present invention.

U.S. Pat. No. 4,000,562 discloses an attachment directly to a vacuum source (instead of a hair clipper) to cause hair to be drawn up through the body of the attachment and permit the hair to be cut at a selected length through a graduated opening mechanism along the length of the attachment using standard household scissors.

U.S. Pat. No. 4,679,322 teaches motor-driven clippers which are connected to suction devices wherein the air flow is used to pull the hair to a convenient cutting position and to efficiently evacuate the clippings. To allow adjustable spacing between the line of cut and the scalp of the subject, the patentees disclose “spacers of various lengths and configurations . . . for attachment to the mouth of the clippers.”

U.S. Pat. No. 4,704,794 describes a hair clipper adapted to be connected to a vacuum source. Representative of the state of the art in such devices, the patentees provide “Intake extensions of various lengths and shapes . . . removably attached to the casing to vary the length of the uncut hair.”

U.S. Pat. No. 5,084,973 describes an adjustable spacer adapted for pneumatic removal of hair cuttings to predetermine length of cut hair. To allow adjustment patentee describes extension members on either of opposing sides of the cutting head of the clippers which can be adjusted equally to vary length or differentially to create angled tapering. As with other comb attachments its usefulness is limited for longer hair styles.

### SUMMARY OF THE INVENTION

The present invention relates to device, easily attachable to and detachable from a powered hair clipper serving as a mechanism for selectively positioning the clipper relative to a subject whereby an operator of the clipper is able to feed a subject's hair through the clipper to a predetermined length and angle. The positioning device is designed and constructed to enable trained operators and operators not trained in the cutting of hair to accurately cut hair more precisely and with greater ease and accuracy.

In some embodiments of the present invention, a positioning device is provided for pre-positioning a conventional powered hair clipper relative to a subject and enabling the clipper operator to feed hair through the clipper by hand. The invention comprises a bracket for attachment to the clipper and an interface structure to be applied against the subject. The bracket attaching to the clipper at the clipping head or the base may be used to determine the distance of the cutting head relative to the interface structure thereby pre-determining a length of hair to be cut via the clipper mechanism.

In some embodiments, the bracket may include a mechanism attachment mechanism for securing the bracket to the hair clipper and a mechanism to control the degree of extension of the attachment. In another aspect, the bracket may be a mechanism shaped to enhance a working area of the operator feeding hair through the clippers.

In still another aspect, in some embodiments, an interface structure may attach to the bracket and determine an angle of the bracket and clipper and thereby pre-determine an angle of hair to be cut. The interface structure includes both a mechanism of attachment to the bracket and may include a mechanism to control the degree of angle of the attachment. The interface structure may incorporate a comb or comb-like structure to assist the operator in the gathering of hair.

In some embodiments the bracket and the interface structure include a semi-rigid structure such as wire which can retain a position in the absence of significant stress. In an alternative embodiment, the bracket and the interface structure comprise a mostly rigid materials such as plastic or metal. In an alternative embodiment, the bracket and the interface structure comprise one or more semi-rigid and rigid material.

Some embodiments allow an adjustable interface structure according to the present invention to replace conventional hair clipper guides by allowing multiple hair lengths to be designated via the adjustment. One adjustable interface structure offers the advantage of being readily available in multiple length designations as well as guide the hair with your fingers into the clipper. Traditional hair clipper guides of a set depth, Such as a No. 2 or No. 4 guide may be misplaced when not in use and limit a haircut according to what guide is available. In addition, the cost factor of manufacturing multiple size clipper guides, and packaging and shipping multiple guides may be mitigated via a single adjustable guide.

In another aspect of the present invention, the bracket is held in position relative to the clipper with detachable fastening material such as hook and loop fasteners (Velcro™) or other commercially available material wherein the bracket and the clipper can be adjusted by detaching, repositioning and re-attaching the same.

In another aspect of the present invention, the bracket is fixedly attached in position relative to the clipper with a banding, clamping or other commercially available a mechanism wherein the bracket and the clipper may be adjusted by overcoming the attachment force between the two created by such a mechanism.

In still another aspect of the present invention, the bracket is slideably held in position relative to the clipper using a track and screw or other commercially available attachment device wherein the bracket and the clipper are adjusted by loosening a screw or clamp which is tightened to hold the bracket and clipper in place relative to each other.

In another aspect of the present invention, a portion of the bracket nearer to an interface structure is perpendicular to the cutting blade to fit more easily between the operator's fingers when feeding hair through the cutting blade in a perpendicular manner.

In some embodiments, the bracket may be mounted in a fixed or slidingly adjustable manner to the blade assembly of the clipper using a commercially available attachment device such as a shoe held in position by one or more of a spring, clamp or screw.

In some embodiments of the present invention, the bracket comprises semi-rigid wire and the position of the clipper is adjusted by arching and de-arching the wire into the desired position.

In some embodiments of the present invention, the interface structure is permanently attached to the bracket in a perpendicular or non-perpendicular orientation.

In some embodiments of the present invention, the interface structure and the bracket are fused into position relative to each other.

In some embodiments of the present invention, the interface structure is adjustably attached to the bracket whereby a single interface structure can be set to a variety of different angles relative to the bracket.

In some embodiments of the present invention the interface structure incorporates combs to assist the operator of the clipper and positioning device in gathering hair to be cut by the clipper blade.

In another aspect of the present invention, the interface is held in position relative to the bracket by a loosening screw or other commercially available a mechanism for adjustable attachment.

In one aspect of some embodiments of the present invention, an operator is able to cut hair with enhanced ease, speed, efficiency and control.

The present invention accordingly comprises the features of construction, combination of elements and arrangement of parts that will be exemplified in the following detailed disclosure, and the scope of the invention will be indicated in the claims. Other features and advantages of the present invention will be apparent from the description, the drawings and the claims.

One general aspect includes a powered hair clipper positioning device for pre-determining a length and angle of hair remaining after being cut by said clipper; said device including: a distance-determining bracket fixedly attachable to a powered hair clipper unit including a clipper blade; and an angle-determining interface structure attached to the bracket, where said bracket and interface structure are configurable to provide work space between said clipper unit and said interface structure thereby enabling an operator to grasp hair and feed the hair across the clipper blade.

Implementations may include one or more of the following features. The device where the distance-determining bracket can be positioned such that at least one pre-determined length of hair remaining on a subject's hair being cut is possible. The device where only one pre-determined length of hair remaining is possible. The device where the angle-determining interface structure can be positioned such that at least one pre-determined angle of hair remaining on a subject's hair being cut is possible. The device where only one pre-determined angle of hair remaining is possible. The device where the work space provided is at least enough to fit the operator's fingers flat between the clipper blade and interface structure. The device where the work space provided is at least enough to fit the operator's fingers flat between the clipper blade and interface structure. The device may also include the device where the work space provided is just enough to fit the operator's fingers flat between the clipper blades and the interface structure. The device where the work space provided is just enough to fit the operator's fingers flat between the clipper blades and the interface structure. Examples may also include the device where the distance-determining bracket is adjustably attached to a clipper body. The device where the distance determining bracket is attached to a clipper blade assembly by a mechanism of a grabbing shoe.

Examples may also include a device where the grabbing shoe is slidingly adjustable along the length of the distance-determining bracket. Examples may also include the device where the bracket, interface structure and/or clipper body incorporates guidelines. The device may also include the device where the angle-determining interface structure is rotatingly attached to the distance-determining bracket. Examples may also include the device where the distance-determining bracket is arched in shape to increase the work space. Examples may also include the device where at least a portion of the distance-determining bracket is perpendicular to a cutting blade to enhance workspace available to the operator of the clipper unit for cutting perpendicular to the clipper blade. Some examples may include the device where the interface structure incorporates a comb. The device may also include examples where tines of the comb arch upward in the center to facilitate the operator of the clipper unit for grasping of hair.

Some embodiments include a method of cutting hair with a powered hair clipper unit having clipper blades. An offset length of a bracket supporting an interface structure may be adjusted to determine an offset distance of the clipper unit blades from a subject receiving a haircut. The interface structure may be placed against the subject receiving a haircut and hair may be fed through the clipper unit blades at a distance approximately equal to the offset.

In some embodiments, an illustration of a subject with multiple zones may be referenced to associate two or more zones with disparate offset lengths. The offset length may be adjusted to a first setting corresponding with a first zone and a second setting corresponding with a second zone. One or more of a zone may be part of a set of zones comprising a styled human or animal haircut.

In still other embodiments, a programmable application may be downloaded into the powered hair clippers wherein the programmable application includes controls for setting one or more clipper cutting depths. The programmable application may be executed to adjust an offset length of a bracket supporting an interface structure for determining an offset a distance of the clipper unit blades from a subject receiving a haircut. The programmable application may be associated with a particular hairstyle, such as, for example, a hairstyle illustrated on a model.

One general aspect includes a method of cutting hair with a powered hair clipper unit including clipper blades, the method including: adjusting an offset length of a bracket supporting an interface structure for determining an offset a distance of the clipper unit blades from a subject receiving a haircut; placing the interface structure against the subject receiving a haircut; and feeding hair through the clipper unit blades at a distance approximately equal to the offset.

The foregoing specific aspects and advantages of the present invention are illustrative of those which can be achieved by the present invention and are not intended to be exhaustive or limiting of the possible advantages that can be realized. Thus, the aspects and advantages of this invention will be apparent from the description herein or can be learned from practicing the invention both as embodied herein or as modified in view of any variations that may be apparent to those skilled in the art. Accordingly, the present invention resides in the novel parts, constructions, arrangements, combinations and improvements herein shown and described. The present invention has several important technical advantages. In various embodiments it may have none, some, or all of these technical advantages.

### BRIEF DESCRIPTION OF THE DRAWINGS

Embodiments and other aspects of the invention are best understood with reference to the detailed disclosure and the following figures, which are meant to illustrate and not limit the invention, and in which:

FIG. 1 illustrates a view depicting some exemplary embodiments of the present invention including a bracket and interface.

FIG. 2 is a view illustrating the positioning of the bracket and interface structure relative to a clipper.

FIG. 3 illustrates a depiction of an operator feeding hair through a clipper positioned using the bracket with attachment device and interface structure.

FIG. 4 illustrates a depiction of an operator feeding hair through a clipper parallel to the cutting blades with bracket including guidelines and interface structure.

FIG. 5 illustrates a depiction of an adjustable interface structure in various positions.

FIG. 6 illustrates a depiction of an arched bracket attached to an adjustable interface structure.

FIG. 7 illustrates a depiction of a bracket in two sections perpendicular to each other.

FIG. 8 illustrates a depiction of an operator feeding hair through a clipper perpendicular to the cutting blades with bracket and interface structure.

FIG. 9 illustrates a depiction of a shoe mount mechanism for attaching to clipper blades.

FIG. 10 illustrates a depiction of an interface structure with guide comb blades incorporated into the structure.

It should be understood by one skilled in the art that the embodiments depicted in the drawings are illustrative and variations of those shown as well as other embodiments described herein may be envisioned and practiced within the scope of the disclosure.

### DESCRIPTION OF THE PREFERRED EMBODIMENT(S)

The present invention provides a mechanism and device for determining an offset distance of an electric hair cutter unit during operation of the hair cutter unit to cut, trim, or style hair. In general, a positioning device according to the present invention enables an operator to manually guide hair into the cutting blades at a predetermined length and distance. The positioning device may be easily attached and detached from the hair clipper unit.

In some embodiments, the device of the present invention may be adjustable such that a single hair cutting device may be adjusted to hold the clipper unit at different distances relative to the subject receiving a haircut. In another aspect, a positioning device according to the present invention facilitates hair being cut at a pre-determined angle. In some embodiments, a single device may be adjustable such that a clipper unit may be held at different angles relative to the subject receiving a haircut.

According to some embodiments, a positioning device provides space to permit an operator to gather hair between their fingers and guide it through a clipper blade positioned at a pre-determined distance and angle from the subject. Embodiments therefore provide a reliable method of hair cutting using the invention to permit confident use by one or both of a skilled and an unskilled hair cutter alike.

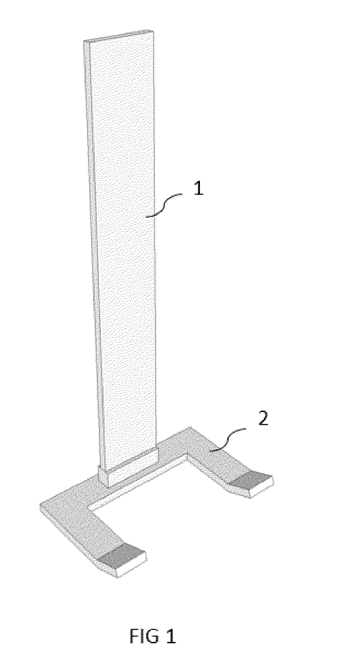

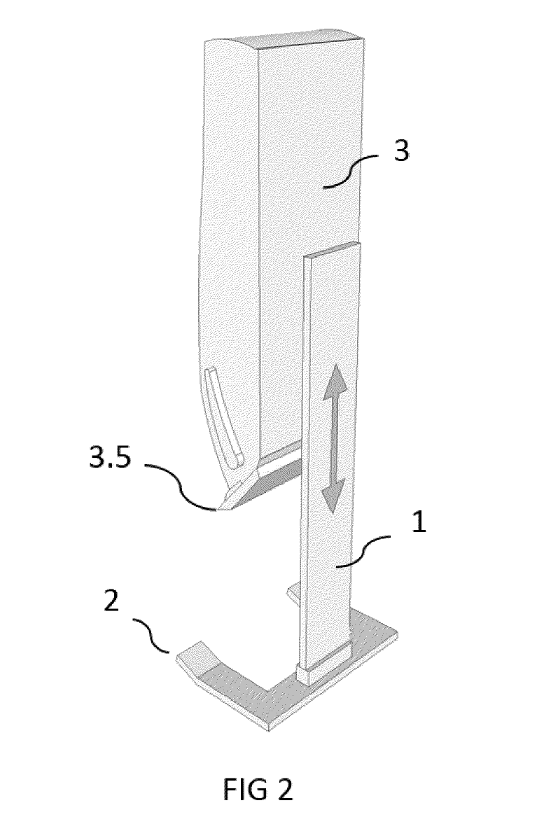

Referring now more particularly to the drawings and specifically to FIG. 1 thereof, the invention clipper positioning device for powered hair clippers is shown comprising bracket 1 and interface structure 2 for positioning relative to a subject and clipper blades 3.5 of clipper 3 in FIG. 2.

Referring to FIG. 2. bracket 1 and interface structure 2 may be formed from any rigid or semi rigid material including, among others, a metallic material, a polymer, metallic wire, 3D printed plastic or metallic based material, aluminum, a petroleum based plastic, other plastic, wood, nylon etc. For flexibility, hygiene, anti-corrosion, cleaning, and economy plastic or plastic coated wire are the preferred material.

The bracket made be fashioned, by way of non-limiting example, via injection molding, via 3-D printing, via molding, via machining, metal forming, welding or other known manufacturing processes. In some specific examples, a custom bracket may be 3-D printed according to a particular need to effect one or more hair styles.

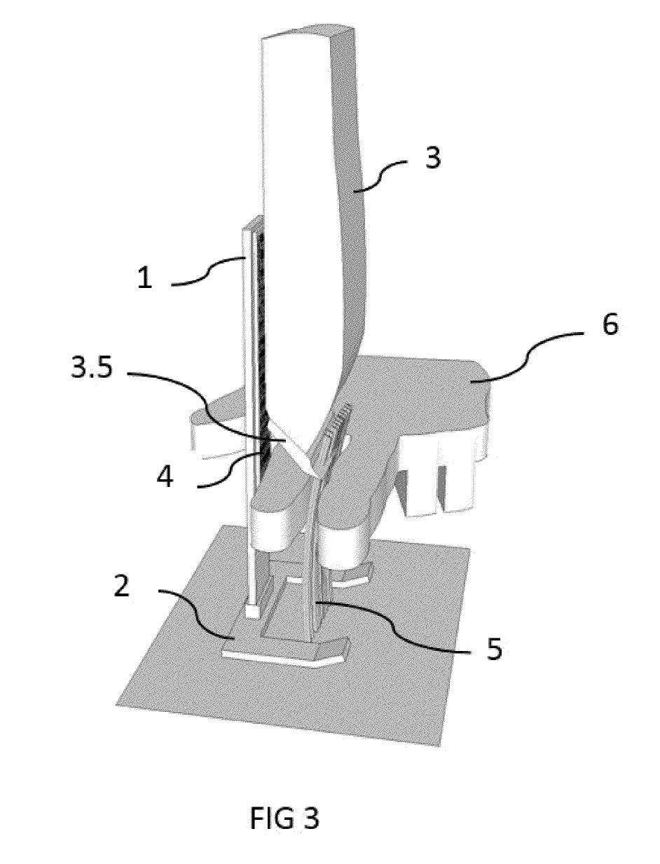

Referring now to FIG. 3 in some embodiments, bracket 1 may be fixedly and/or removably attached to and detached from a powered hair clipper unit. In some embodiments, an adhering material 4 permanently or semi-permanently may be used to attach bracket 1 to the clipper unit.

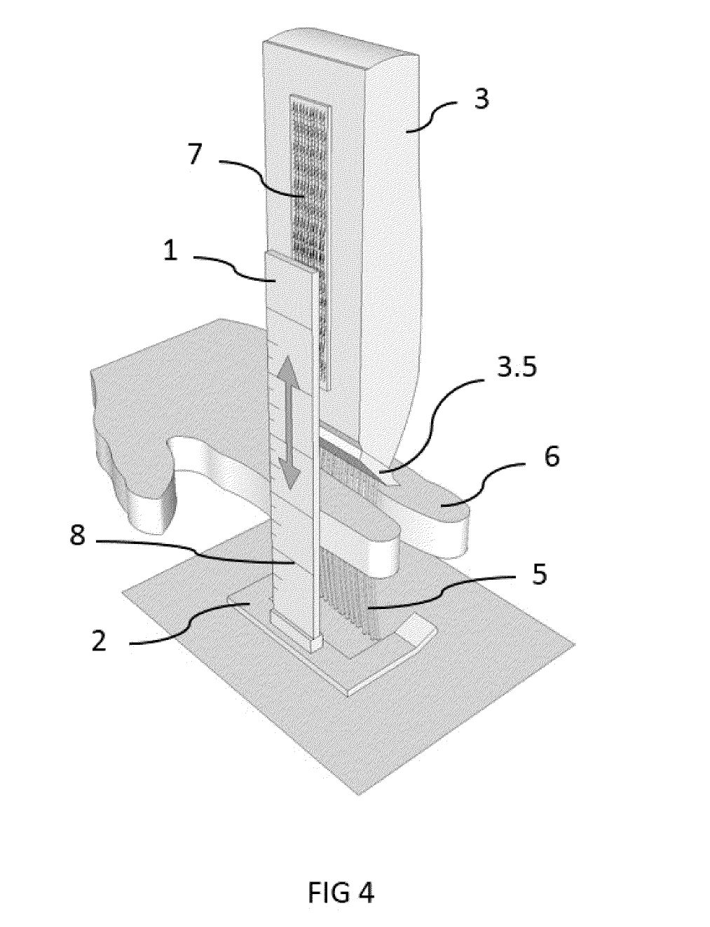

Referring now to FIG. 4 in some embodiments, an adhering material 7 may be used to permanently or semi-permanently attach the bracket to a hair clipper 3.

In some embodiments, an adhesive material may be incorporated into a tape, hook and loop fastener or other material to fixedly or removably attach the bracket 1 to the clipper 3.

In some embodiments, the bracket 1 and the clipper 3 may removably adhere and re-adhere to each other. Adhering material 4 and material 7 may be formed from any removably attaching material including among others magnets, snaps, adhesive, hook and loop fastener, (Velcro or a Velcro-like material) etc. For flexibility, hygiene, anti-corrosion, cleaning, and economy Velcro or a Velcro-like material is the preferred material. Alternatively, bracket 1 may be attached to and detached from hair clipper 3 using a band, bracket, clamp or other commercially available a mechanism of joining.

Referring to FIG. 4, adjustment of the distance between the interface structure 2 and clipper blades 3.5 may be provided for by attaching bracket 1 to clipper 3 by attaching and adhesive device, such as, by way of example, adhering material 7 may comprise a Velcro strip in the desired position to be located opposite to adhering material 4 which may be the corresponding Velcro strip for attachment as shown in FIG. 3. Positioning may be assisted using guidelines 8 incorporated on bracket 1.

It is appreciated that similar guidelines can be placed on one or both of bracket 1 or clipper 3. Guidelines can be matched against each other or any part of the clipper or bracket to achieve the desired distance of separation between clipper blade 3.5 and interface structure 2.

Continuing with FIG. 4, interface structure 2 to be rested against a subject such that operator 6 is able to gather and feed hair 5 through clipper blades 3.5 to achieve a pre-determined length of remaining hair.

It is appreciated that some embodiments may include adjustable brackets of a long length compared to other adjustable brackets of a shorter length for especially long or short cut lengths. It is also appreciated that some embodiments may include a bracket attachable without an adjustment feature.

It is also appreciated that FIG. 4 illustrates an interface structure attached to an external surface of a clipper unit. One skilled in the art will understand that an attachment mechanism may be built into or otherwise made an integral part of a clipper. For example, a clipper body may include a molded channel for receiving and supporting a clipper interface structure. An attachment device, such as a spring loaded fastener, a set screw, a clip, a pin or other known fastening mechanism may be used to secure the clipper interface structure to the clipper body at an operator determined depth. In some more sophisticated embodiments, an automated mechanism, such as a stepper motor, or a linear actuator or piston, may be included in a clipper and used to adjust a cutting depth set by the interface structure. A visual depth indicator may be used to indicate to a user a depth to which the interface structure is set.

Automated clipper cutting depth adjusters may be used with downloadable applications to emulate a known hair cutting style. For example, a picture of a media star or model may be used to illustrate a particular hair style. A person who wishes to emulate the modeled hair style may choose an illustration of a modeled hair style and a downloadable app may be used to program a clipper to appropriate lengths for one or more areas to be cut. The hair cutter operator then applies the clipper to the specified areas of the subject associated with a clipper depth setting. The app may designate different depths for various portions of the subject.

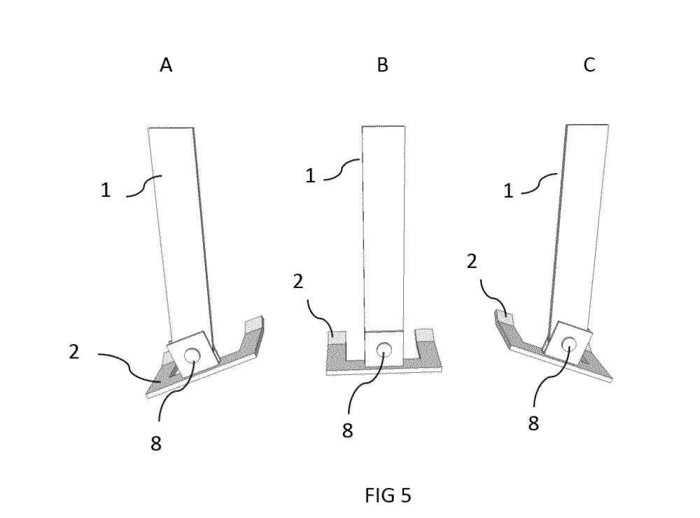

Referring now to FIG. 5 illustrations A, B and C depict interface structure 2 rotatably attached to bracket 1 by a mechanism of a commercially available adjustment element 8.5, such as a nut and bolt, screw or pin, which can be set to hold interface structure 2 and bracket 1 in predetermined angular positions relative to each other such as in illustration A, B and C. In some embodiments the adjustable element includes a nut and bolt which can be tightened to hold the bracket and interface structure in position. In some alternative embodiments, the adjustable element includes a screw which tightens through threads in either or both of the bracket and interface structure. In some alternative embodiments, the element may incorporate a pin, latch or clamp to lock the bracket and interface structure into position. It is appreciated that guideline marks may be incorporated into one or both of the bracket and interface structure in order to aid in determining position. In some more sophisticated embodiments, an automated mechanism, such as a stepper motor, or a linear actuator or piston, may be included in a clipper and used to adjust the angle of the interface. A visual angle indicator may be used to indicate to a user the angle at which the interface structure is set.

Automated clipper cutting angle adjusters may be used with downloadable applications to emulate a known hair cutting style wherein an app associated with a particular style is used to program the clipper to select the appropriate interface angle settings to apply to corresponding areas of the subject's hair to be cut.

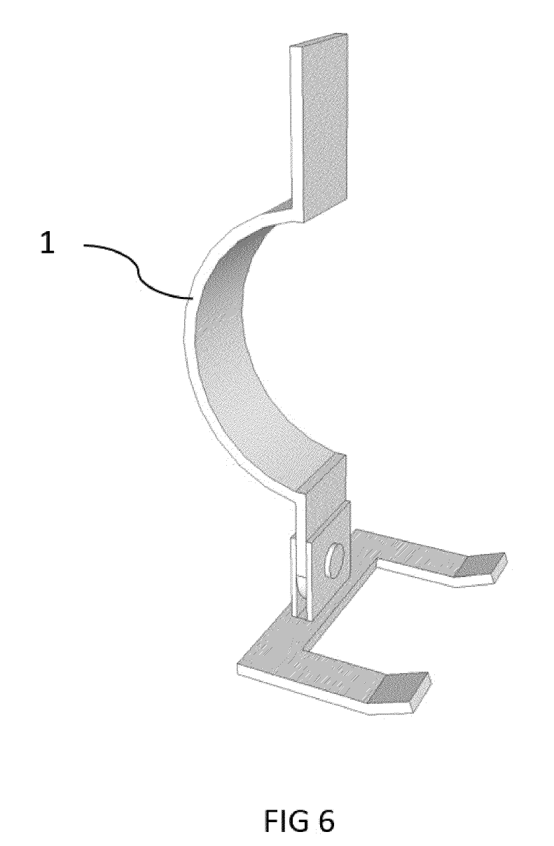

Referring now to FIG. 6, bracket 1 is shown in an arched configuration providing additional space for an operator to manipulate hair with their fingers beneath a cutting blade of a clipper. It is appreciated that bracket 1 can be formed in various configurations to enhance operator experience.

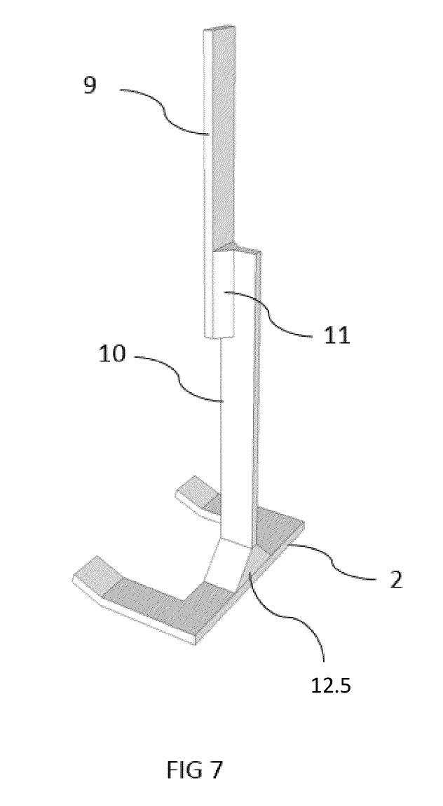

Referring to FIG. 7, bracket 1 in FIG. 1 is shown in a two part configuration wherein first part 9 and second perpendicular part 10 are joined together by weld 11. Perpendicular part 10 is attached to interface structure 2 by weld 12.5. It is appreciated that a similar configuration could be formed by twisting of a single bracket.

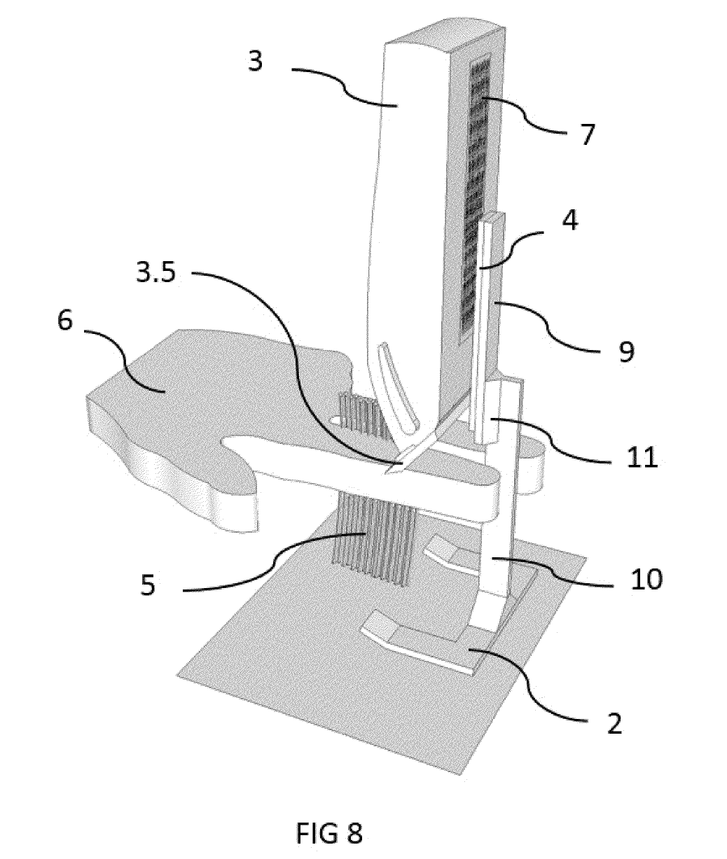

FIG. 8 depicts second perpendicular part 10 in line with hair 5 being fed by operator 6 for cutting by clipper blade 3.5 of clipper 3. It is noted that second perpendicular part 10 is positioned to enable operator 6 to pass its fingers around part 10 or adjacent to part 10 as hair is fed through the clipper perpendicular to clipper blade 3.5 of clipper 3.

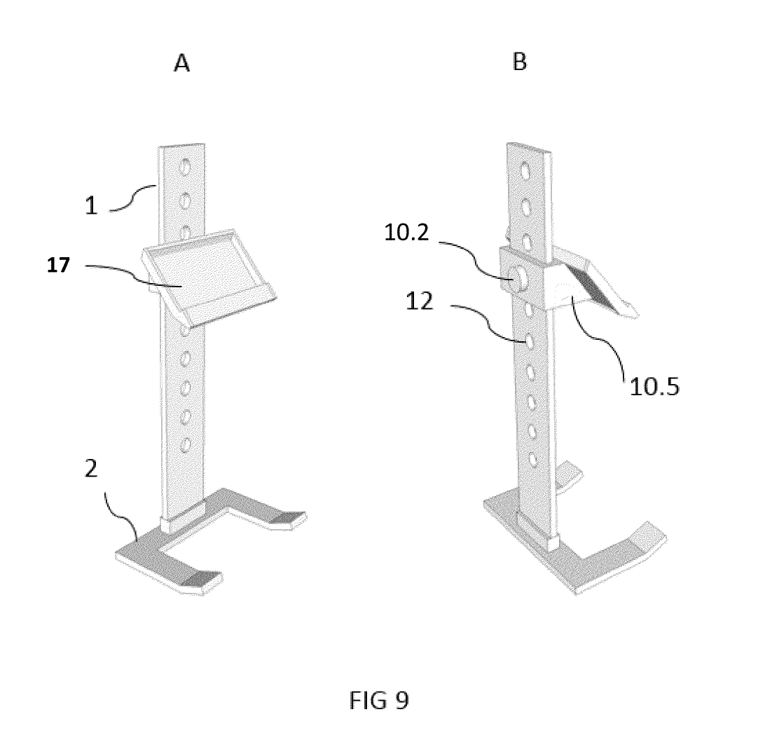

Referring now to FIG. 9, diagrams A and B show different views of bracket 1 and interface structure 2 with a mechanism for attaching to the clipper blade assembly of a clipper comprising a shoe mount 17, bracing mount 10.5 and pin 10.2. The assembly of the clipper blade 3.5 of clipper 3 in FIG. 3 is held in place by shoe mount 17 which incorporates a commercially available mechanism for attaching attachments to clipper blades including among others mechanisms used to attach guide comb attachments and clipper blade protective attachments to clipper blades. Shoe mount 17 incorporates bracing mount 10.5 which fits slidingly around bracket 1 and may be fixed into position along the length of the bracket by inserting pin 10.2 into an opening of corresponding size and shape 12.

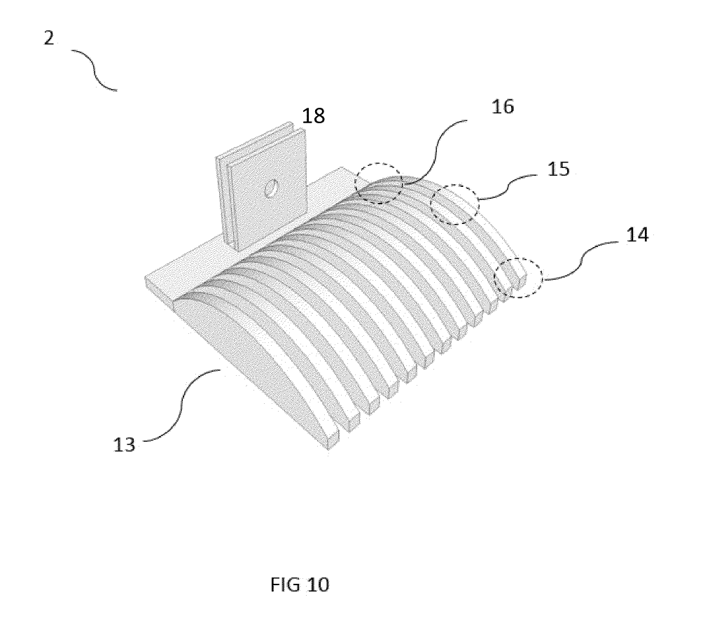

Referring now to FIG. 10 an interface structure 2 is illustrated with guide comb blades 13 incorporated into the structure. The blades assist operator 6 in FIG. 4 in the gathering of hair to feed through clipper blade 3.5 in FIG. 3. Forward area 14 of the comb blades initially engages hair as it is combed forward into higher area 15 positioning hair to be grasped by operator with lower area 16 making it easier for operator to grasp hair. It is appreciated that guide comb blades incorporated into the interface structure may be configured in a variety of different shapes and sizes. A flange 18 may be included for attachment to the clipper.

In some embodiments of the present invention, the bracket may be about 6 inches long.

In some embodiments of the present invention, the bracket may be shorter than 6 inches, or longer than 6 inches.

In some embodiments of the present invention, the interface structure is fixed at or about 90 degrees relative to the bracket.

In another aspect of the present invention the interface structure may be fixed at an angle other than 90 degrees relative to the bracket.

In another aspect of the present invention, the bracket structure may be arched back and way from the clipper head and interface structure to provide additional access room for the operator to feed hair into the clipper unit blades.

From the foregoing it is seen that the invention provides a fixed or adjustable length positioning bracket with fixed or adjustable angular interface structure attached for cutting hair at various lengths and angles with ease incorporating which is uniquely simple in structure and operation, and otherwise fully accomplishes its intended objects.

What is claimed is:

1. A powered hair clipper positioning device for pre-determining a length and angle of hair remaining after being cut by said clipper; said device comprising:
a distance-determining bracket fixedly attachable to a powered hair clipper unit comprising a clipper blade; and
an angle-determining interface structure attached to the bracket, wherein said bracket and interface structure to provide work space between said clipper unit and said interface structure thereby enabling hair to be guided across the clipper blade at a predetermined length.

2. The device of claim 1 wherein the distance-determining bracket can be positioned to provide a pre-determined length of hair remaining on a subject following a cut by the clipper.

3. The device of claim 2 wherein only one pre-determined length of hair remaining is possible.

4. The device of claim 1 wherein the angle-determining interface structure can be positioned such that at least one pre-determined angle of hair remaining on a subject is possible.

5. The device of claim 4 wherein only one pre-determined angle of hair remaining is possible.

6. The device of claim 1 wherein the work space provided is at least enough to fit an operator's fingers flat between the clipper blade and interface structure.

7. The device of claim 6 wherein the work space provided is just enough to fit the operator's fingers flat between the clipper blades and the interface structure.

8. The device of claim 1 wherein the distance-determining bracket is adjustably attached to a clipper body.

9. The device of claim 1 wherein the distance determining bracket is attached to a clipper blade assembly by a mechanism of a grabbing shoe.

10. The device of claim 9 wherein the grabbing shoe is slidingly adjustable along the length of the distance-determining bracket.

11. The device of claim 1 wherein the bracket, interface structure and/or clipper body incorporates guidelines.

12. The device of claim 1 wherein the angle-determining interface structure is rotatingly attached to the distance-determining bracket.

13. The device of claim 1 wherein the distance-determining bracket is arched in shape to increase the work space.

14. The device of claim 1 wherein at least a portion of the distance-determining bracket is perpendicular to a cutting blade to enhance workspace available to an operator of the clipper unit for cutting perpendicular to the clipper blade.

15. The device of claim 1 wherein the interface structure incorporates a comb.

16. The device of claim 15 wherein tines of the comb arch upward in the center to facilitate the operator of the clipper unit grasping of hair.

17. A method of cutting hair with a powered hair clipper unit comprising clipper blades, the method comprising:
adjusting an offset length of a bracket supporting an interface structure for determining an offset a distance of the clipper unit blades from a subject receiving a haircut;
placing the interface structure against the subject receiving the haircut; and
feeding hair through the clipper unit blades at a distance approximately equal to the offset.

18. The method of claim 17 additionally comprising the steps of:
referencing an illustration of the subject indicating a plurality of zones;
associating two or more zones with disparate offset lengths;
adjusting the offset length to a first setting corresponding with a first zone; and
adjusting the offset length to a second setting corresponding with a second zone.

19. The method of claim 17 additionally comprising the steps of:
installing a programmable application into the powered hair clippers wherein the programmable application includes controls for setting one or more of a hair length;
executing the programmable application to adjust an offset length of the bracket supporting an interface structure for determining an offset of a distance of the clipper unit blades from the subject receiving the haircut;
placing the interface structure against the subject receiving the haircut; and
feeding hair associated with an area of the subject designated by the programmable application through the clipper unit blades at a distance approximately equal to the offset.

20. The method of claim 19 wherein the programmable application is associated with a specified hairstyle.
